(19) United States
(12) Patent Application Publication
(10) Pub. No.: US 2025/0132519 A1
(43) Pub. Date: Apr. 24, 2025

(54) SILICONE SEAL HAVING A BUSHING FOR SEALING DOUBLE RAILS

(71) Applicant: Lisa Dräxlmaier GmbH, Vilsbiburg (DE)

(72) Inventors: Stefan WIMMER, Hohenthann (DE); Johannes TAUSCH, Pfaffenhofen a.d. Ilm (DE); Franziska NEUMAYER, Geisenhausen (DE)

(73) Assignee: Lisa Dräxlmaier GmbH, Vilsbiburg (DE)

(21) Appl. No.: 18/989,661

(22) Filed: Dec. 20, 2024

Related U.S. Application Data
(63) Continuation of application No. PCT/EP2023/064083, filed on May 25, 2023.

(30) Foreign Application Priority Data
Jun. 20, 2022 (DE) 102022115266.9

(51) Int. Cl. H01R 13/52

(52) U.S. Cl. CPC H01R 13/5205

(57) ABSTRACT

An arrangement for sealing two mutually parallel running flat conductors against a housing of an interface includes an inner ring with two through holes, which are mutually spaced by a central bar, for accommodating two parallel running flat conductors. The flat conductors respectively face each other with a wide side. The inner ring abuts all sides of flat conductors located in the through holes, and seals the flat conductors against the inner ring. The arrangement furthermore has an outer ring having an opening. The opening accommodates the inner ring, and the outer ring abuts with its inner surface on the inner ring and seals the inner ring against the outer ring. An outer surface of the outer ring abuts against a housing and seals the outer ring against the housing.

### CROSS-REFERENCE TO RELATED APPLICATIONS

This application is a continuation of International Application No. PCT/EP2023/064083, filed on May 25, 2023, which claims priority to and the benefit of DE 10 2022 115 266.9 filed on Jun. 20, 2022. The disclosures of the above applications are incorporated herein by reference.

### FIELD

The present disclosure relates to an arrangement for sealing two mutually parallel running flat conductors against a housing of an interface.

### BACKGROUND

The statements in this section merely provide background information related to the present disclosure and may not constitute prior art.

In the prior art, conductors running toward an interface, such as, for example, a connector housing, are usually sealed to inhibit the ingress of water or dirt and provide a long service life. This is particularly advantageously used in the automotive sector if the components are exposed to environmental influences. A seal of a material such as rubber or silicone can be used with some conductors. This is, however, not readily possible with conductors that run side by side into a connector housing or an interface. For these conductors, entire components can be poured out with resins in order to produce a seal. However, this has a consequence that the components are heavy, expensive to produce, and have a long processing time during manufacture, for example, for the hardening of the sealing compound. Flat conductors can be additionally or alternatively sealed with an 8 series seal.

### SUMMARY

This section provides a general summary of the disclosure and is not a comprehensive disclosure of its full scope or all of its features.

The present disclosure provides an improved arrangement, which can be economically and easily installed and makes possible the sealing of two flat conductors or double rails running side by side toward an interface.

The described examples likewise apply to the arrangement for sealing two flat conductors running parallel to each other against an interface as well as a method for installing the arrangement. Synergistic effects can result from various combinations of examples even if they are not described in detail.

An arrangement for sealing two mutually parallel running flat conductors from a housing of an interface is proposed according to one aspect of the present disclosure. The arrangement has an inner ring as well as an outer ring. The inner ring has a first through hole configured for accommodating a first flat conductor, and a second through hole configured for accommodating a second flat conductor. As a result, the first through hole and the second through hole run parallel to each other and are separated from each other by means of a central bar. The first through hole and the second through hole have a longitudinal shape in cross section and a long side of the first through hole faces toward a long side of the second through hole. The inner ring is configured for the purpose of abutting against the flat conductor and sealing the flat conductor against the inner ring on all sides of a circumferential surface of the flat conductor if a respective flat conductor is located in the first through hole and/or in the second through hole. The outer ring has an opening, wherein the opening is configured for accommodating the inner ring, and the outer ring is configured for abutting with an inner surface against the inner ring on all sides of a circumferential surface of the inner ring and sealing the inner ring against the outer ring. The outer ring also has an outer surface configured for abutting against a housing and sealing the outer ring against the housing.

Two flat conductors running parallel one above the other or side by side can in this way be advantageously sealed to interfaces, such as, for example, housings or connectors. The flat conductors can be individual conductors having an elongated cross section or also a bundle of several conductors arranged side by side. The two flat conductors run thereby preferably parallel to each other in such a way that respectively one wide, flat side of the flat conductor faces toward the other. The sealing arrangement according to the present disclosure has two components. The inner component, the inner ring, seals thereby to the flat conductors, which project through the openings or holes in the inner ring. The inner ring abuts thereby tightly against the two flat conductors and encloses them along a complete cross section of the flat conductor. The flat conductors are located at a predetermined distance from each other so that a central bar of the inner ring is located between the two holes of the inner ring and fills, and thus seals, the gap between the two flat conductors. The holes of the inner ring are preferably manufactured in a shape that corresponds to the shape of the flat conductors. The second component of the sealing arrangement according to the present disclosure, the outer ring, is put over like a grommet over the inner component, the inner ring, and seals the gap between the inner ring and the interface. For this purpose, the outer ring has an opening, wherein an inner surface of the opening in assembled state abuts tightly against the inner ring and is thus sealed to the inner ring. The outer ring abuts with one outer surface on a housing or on an interface and is sealed thereby to the interface. The outer ring is preferably enclosed by the housing so that the outer ring abuts against an inner surface of the housing. As a result, the two components can be easily pushed over the flat conductors. This arrangement according to the present disclosure can be used if no conventional seals, such as, for example, 8 series seals, can be mounted due to reasons of adaptability to installation. Time and costs can be saved thereby in contrast to a poured on variant. This sealing system according to the present disclosure can be advantageously used with various conductor or rail cross sections and various tightness classes with, for example, busbars or HVDS double rails. Seals can be produced between the rails in this way. The arrangement has a small installation space as well as an easy assembly. Through the modular example with inner ring and outer ring, the inner ring that seals the gap can first be pulled over the flat conductors during assembly, and the outer ring can then be pulled over the inner ring that is sealed to the interface. This example also makes possible the realization of various sealing standards, such as IP classes. As material for the seal can be used, for example, silicone, rubber, or similar materials.

In one example of the present disclosure, the inner ring can have a slot configured for opening the inner ring at the first through hole or at the second through hole at a side opposite to the central bar in order to facilitate the insertion of a flat conductor into the first through hole or into the second through hole of the inner ring. In order to install, the inner ring is slotted at an outer side. The respective opening or the through hole of the inner ring can be opened or flipped open for a simplified installation on the flat conductor. The flat conductor can be easily inserted through the hole that has been enlarged in this way. After the flat conductor has been inserted, the two parts of the inner ring, which are separated by the slot, are brought again in contact so that the inner ring rests flush on the flat conductor on all sides. The grommet or the outer ring additionally seals this advantageous slot so that various sealing standards can be fulfilled.

In one example of the present disclosure, the slot has a profile that is configured for making possible a mutual engagement of the parts of the inner ring that are separated by the slot in order to provide a closure of the inner ring at the slot. This profile can have a jagged course so that the parts of the inner ring separated by the slot mutually engage like two puzzle pieces. A secure connection of the parts is achieved therewith, so that these parts could not independently separate from each other without an outside influence. The tightness of the arrangement is further increased by means of the profile.

In one example of the present disclosure, the inner ring has a first slot at the first through hole and a second slot at the second through hole. Both through holes of the inner ring are advantageously respectively provided with a slot, so that the installation of the inner ring on the first flat conductor as well as on the second flat conductor is facilitated.

In one example of the present disclosure, the arrangement has furthermore a strain relief configured for attachment onto the mutually parallel running flat conductors beside the inner ring and the outer ring, in order to inhibit mechanical stress on the inner ring and the outer ring. This additional strain relief ahead of the seal is suitable for reducing vibrations at the seal. The strain relief can introduce tractive forces, which act on the flat conductors, directly into a housing of the interface, so that no forces are exerted via the flat conductor or conductors onto the inner ring and the outer ring.

In one example of the present disclosure, the strain relief includes two identical parts, which are configured so that they are pushed laterally from mutually opposite sides of the flat conductors onto the flat conductors and snap together. The strain relief can advantageously include two identical parts which are pushed onto the flat conductors during installation and are then connected to each other. A mechanical force transfer from the flat conductors to the strain relief in at least one direction should additionally be possible.

In one example of the present disclosure, the arrangement furthermore has a housing which is configured for enclosing the inner ring and the outer ring, and which has a contact surface configured for abutting against the outer surface of the outer ring and sealing the outer ring against the housing. This housing can be a part of the interface to which the flat conductors are connected. However, it can also be part of the sealing arrangement according to the present disclosure, so that the housing is connected to the interface. The housing can have a hollow space through which run the flat conductors enclosed by the inner ring and the outer ring. As a result, the outer ring abuts tightly against the housing, so that a gap between the outer ring and the housing is closed and thus sealed.

In one example of the present disclosure, the outer surface of the outer ring has a profiled surface with a multitude of sealing lips. The outer surface of the outer ring is advantageously configured in such a way that a sealing effect as well as an adaptability to installation of the outer ring in the housing are improved. This can be achieved by means of a multitude of sealing lips, which run parallel to each other along the outer periphery of the outer ring.

In one example of the present disclosure, the peripheral surface of the inner ring and the inner surface of the outer ring have a complementary profile, which is configured for providing a secure fit of the outer ring on the inner ring. The inner ring and the outer ring are configured so that they lie one atop the other and create a tight seal between them. For this purpose, the inner ring is profiled on its outer surface and the outer ring is profiled on its inner surface preferably along the peripheral direction around the flat conductors. This profile can include a number of grooves or elevations running transversely to the direction to be sealed along the flat conductors.

In one example according to the present disclosure, a width of the outer ring in longitudinal direction of the flat conductors is greater than a corresponding width of the inner ring, and the outer ring is configured so as to fit with a part that projects over the inner ring on the first flat conductor as well as on the second flat conductor. Through this greater width of the outer ring with respect to the inner ring is achieved an improved sealing effect. An additional seal of the slot or slots of the inner ring is achieved especially by means of the created overhang of the outer ring over the inner ring, whereby the outer ring comes in contact with the flat conductors. This can lead to a greater tightness class.

The advantages that the aspects mentioned above offer apply thus equally for all other aspects and vice versa.

The present disclosure fundamentally relates to an arrangement for sealing two mutually parallel running flat conductors against a housing of an interface. The arrangement has an inner ring with two through holes for accommodating two parallel running flat conductors that are spaced from each other by a central bar, wherein the flat conductors respectively face each other with a wide side. The inner ring is configured for abutting from all sides against a flat conductor located in the through hole and sealing the flat conductor against the inner ring. The arrangement furthermore has an outer ring with an opening, wherein the opening is configured for accommodating the inner ring, and wherein the outer ring is configured for abutting with its inner surface onto the inner ring and sealing the inner ring against the outer ring. An outer surface of the outer ring is configured for abutting against a housing and sealing the outer ring against the housing.

Further features, advantages, and application possibilities of the present disclosure arise from the following description of advantageous examples and the accompanying figures. In addition, further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation in longitudinal section of an arrangement for sealing two mutually parallel running flat conductors against a housing of an interface according to an example of the present disclosure;

FIG. 2 is a cross section of an inner ring of the arrangement according to various teachings of the present disclosure;

FIG. 3 is a cross section of an outer ring of the arrangement according to various teachings of the present disclosure;

FIG. 4 is a cross section of the arrangement with an inner ring and an outer ring on two flat conductors according to various teachings of the present disclosure;

FIG. 5 is a perspective view of an inner ring of the arrangement on two flat conductors according to various teachings of the present disclosure;

FIG. 6 is a perspective view of an outer ring above an inner ring of the arrangement on two flat conductors according to various teachings of the present disclosure;

FIG. 7 is a perspective view of the arrangement with one half of the strain relief on two flat conductors according to various teachings of the present disclosure;

FIG. 8 is a perspective view of the arrangement with a strain relief on two flat conductors according to various teachings of the present disclosure; and

FIG. 9 is a perspective view of the arrangement in a housing on two flat conductors according to various teachings of the present disclosure.

The figures are merely schematic representations and serve only for explaining the present disclosure. Elements that are identical or have an identical function are provided throughout with the same reference numerals.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

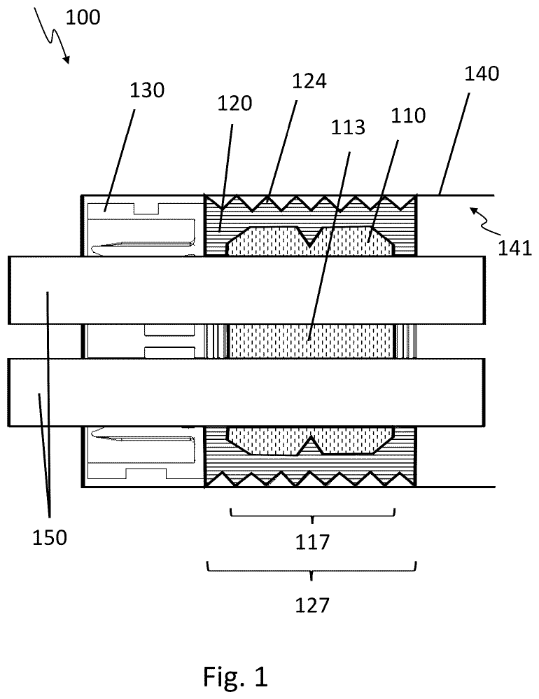

FIG. 1 shows a schematic representation in longitudinal section of an arrangement 100 for sealing two mutually parallel running flat conductors 150 against a housing 140 of an interface according to an example of the present disclosure. An inner ring 110 with a central bar 113 is mounted in such a way on the mutually parallel flat conductors 150 that each flat conductor 150 runs through its own through hole 111, 112 in the inner ring. The inner ring 110 abuts tightly against the flat conductors 150 and inhibits the passage of foreign bodies, such as dirt or water, along the flat conductors 150 through the inner ring 110. The central bar 113 seals the gap located between the flat conductors 150. An outer ring 120 of the arrangement 100 is installed outside of the inner ring and rests flush against it in order to seal the gap between the inner ring 110 and the outer ring 120 and inhibits the passage of foreign bodies. The outer ring 120 sealingly abuts with sealing lips 124 arranged on its outer side against a contact surface 141 of a housing 140. The width 127 of the outer ring 120 along the flat conductors 150 is thereby greater than the corresponding width 117 of the inner ring 110, so that the outer ring 120 encompasses the inner ring 110 and can likewise establish a sealing contact with the flat conductors 150, which increases the sealing effect. A strain relief 130 is installed beside the inner ring 110 and the outer ring 120 in the housing 140 in order to reduce the mechanical stress on the inner ring 110 and the outer ring 120.

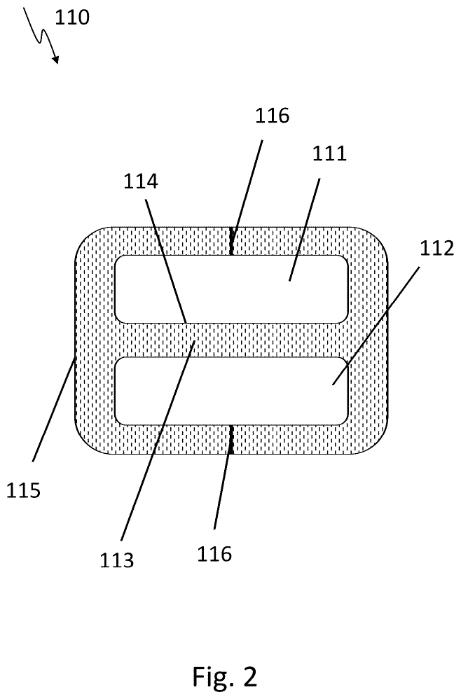

FIG. 2 shows a cross section of an inner ring 110 of the arrangement 100 according to an example of the present disclosure. The first through hole 111 and the second through hole 112, which face each other respectively with a long side 114 and are separated from each other by means of a central bar 113, are shown here. In this example, the inner ring 110 has a slot on both through holes 111, 112 at which the inner ring 110 can be opened and closed in order to facilitate the installation on the flat conductors 150, and subsequently be able to restore the tightness. A peripheral surface 115 is configured so as to seal the outer ring 120 to the outside.

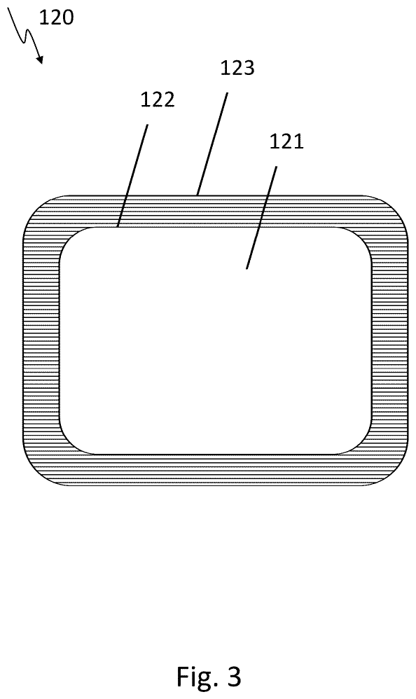

FIG. 3 shows a cross section of an outer ring 120 of the arrangement 100 according to an example of the present disclosure. The latter has an opening 121 into which the inner ring 110 can be inserted in order to sealingly abut against the inner surface 122 of the outer ring 120. The outer ring 120 can have sealing lips 124 on its outer surface 123 in order to seal to the housing 140.

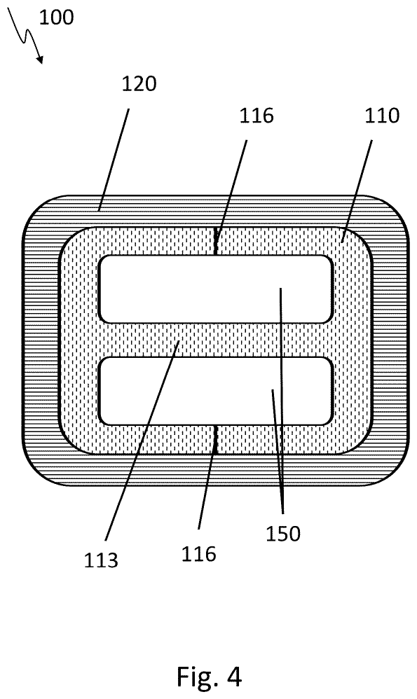

FIG. 4 shows a cross section of the arrangement 100 with an inner ring 110 and an outer ring 120 mounted around the inner ring on two flat conductors 150 according to an example of the present disclosure. The flat conductors 150 are located in the through holes 111, 112 of the inner ring 110 and are mutually spaced by means of the central bar 113. The inner ring 110 has a slot 116 as installation aid in this example.

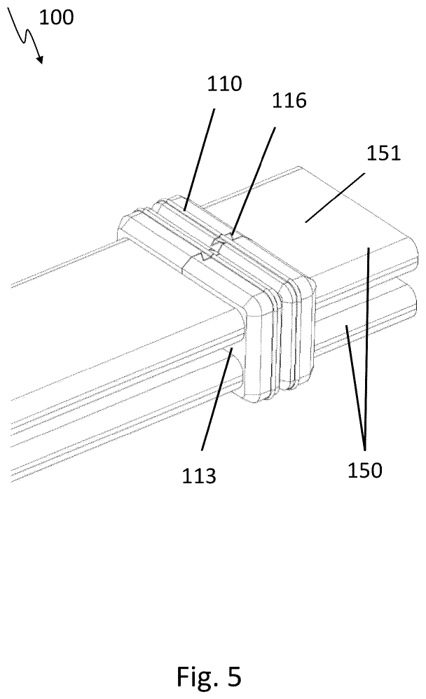

FIG. 5 shows a perspective view of an inner ring 110 of the arrangement 100 on two flat conductors 150 according to an example of the present disclosure. The inner ring 110 encompasses thereby a peripheral surface 151 of both flat conductors 150, wherein a central bar 113 projects between the two flat conductors 150. The profiled slot 116 in the inner ring 110, by means of which the inner ring 110 can be opened and securely closed, can be seen especially well in this example.

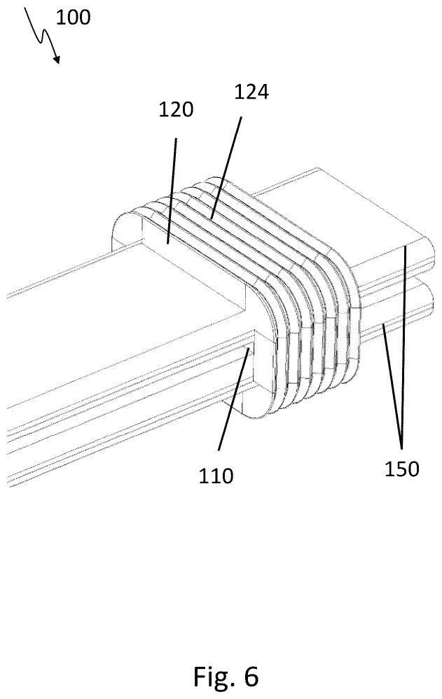

FIG. 6 shows a perspective view of an outer ring 120 on top of an inner ring 110 of the arrangement 100 on two flat conductors 150 according to an example of the present disclosure. After the inner ring 110 is installed on the flat conductors 150, the outer ring 120 is put over the inner ring 110 and seals with its outer sealing lips 124 against a housing 140 of an interface.

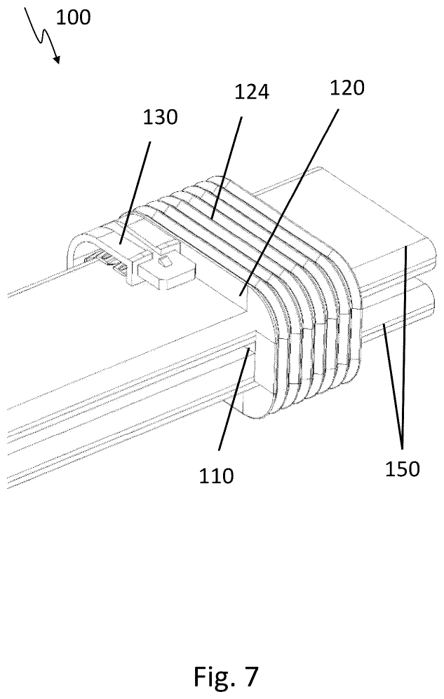

FIG. 7 shows a perspective view of the arrangement 100 with one half of the strain relief 130 on two flat conductors 150 according to an example of the present disclosure. The first part of the strain relief was installed here already beside the inner ring 110 and the outer ring 120.

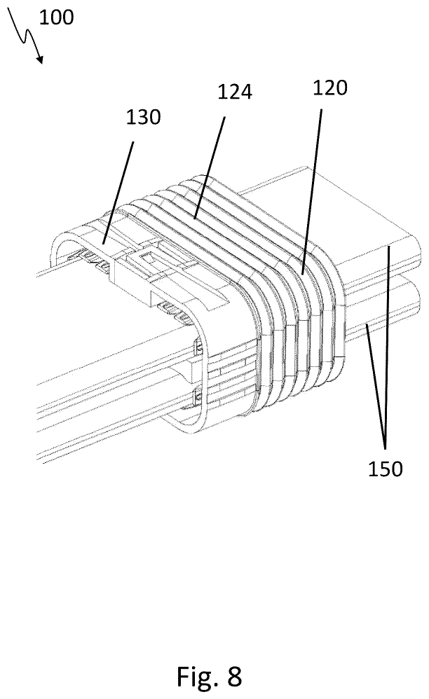

FIG. 8 shows a perspective view of the arrangement 100 with a strain relief 130 on two flat conductors 150 according to an example of the present disclosure. In this example, the arrangement 100 has a strain relief 130 in addition to the inner ring 110 and the outer ring 120, wherein the two halves of the strain relief 130 snap into each other. A one-piece strain relief 130 can also alternatively be affixed.

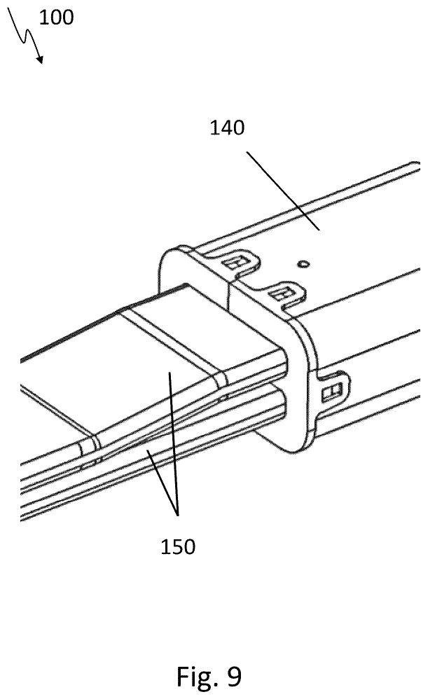

FIG. 9 shows a perspective view of the arrangement 100 in a housing 140 on two flat conductors 150 according to an example of the present disclosure. Here, the arrangement 100 is enclosed by a housing 140, which surrounds the inner ring 110, the outer ring 120, and preferably a strain relief 130. The two flat conductors 150, which are parallel to each other at least in some sections, project from the housing 140 at one end.

Even though the present disclosure was illustrated and described in detail in the drawings and the above description, these drawings and descriptions are to be understood as merely illustrative or exemplary and not as limiting. The present disclosure is not limited to the disclosed examples. Other variations of the disclosed examples can be understood and realized by persons skilled in the art who implement the claimed present disclosure on the basis of the drawings, the disclosure, and the dependent claims.

It should be additionally noted that the term “comprising” does not exclude other elements or steps and “one” or “a” does not exclude a plurality. It should also be pointed out that features or steps which were described with reference to one of the above examples can also be used in combination with other features or steps of other examples described above. The reference numerals in the claims are not to be considered as a limitation.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An arrangement for sealing two mutually parallel running flat conductors against a housing of an interface, the arrangement comprising:
an inner ring having a first through hole configured to accommodate a first flat conductor, a second through hole configured to accommodate a second flat conductor, the first through hole and the second through hole run mutually parallel to each other and are separated from each other by a central bar, the first through hole and the second through hole have an elongated shape in cross section, with a first long side of the first through hole facing toward a second long side of the second through hole, and the inner ring is configured to abut against the first flat conductor and the second flat conductor on all sides of a peripheral surface of each of the first flat conductor and the second flat conductor within a respective one of the first through hole and the second through hole to seal the first flat conductor and the second flat conductor against the inner ring; and
an outer ring having an opening configured to accommodate the inner ring, the outer ring configured to abut the inner ring along an inner surface of the outer ring and on all sides of a peripheral surface of the inner ring to seal the inner ring against the outer ring, and the outer ring includes an outer surface configured to abut against a housing and sealing the outer ring against the housing.

2. The arrangement according to claim 1, wherein the inner ring includes a slot on one side lying opposite to the central bar, and the slot is configured to open the inner ring at the first through hole or at the second through hole to facilitate an insertion of the first flat conductor or the second flat conductor into the respective one of the first through hole or into the second through hole of the inner ring.

3. The arrangement according to claim 2, wherein the slot includes a profile configured to mutually engage parts of the inner ring that are separated by the slot to provide a closure of the inner ring at the slot.

4. The arrangement according to claim 2, wherein the inner ring includes a first slot at the first through hole and a second slot at the second through hole.

5. The arrangement according to claim 1, further comprising a strain relief configured to mount in the housing beside the inner ring and the outer ring to inhibit mechanical stress of the inner ring and the outer ring.

6. The arrangement according to claim 5, wherein the strain relief includes two identical parts configured to move laterally from mutually opposite sides of the first flat conductor and the second flat conductor to snap together.

7. The arrangement according to claim 1, comprising the housing that is configured to enclose the inner ring and the outer ring, and a contact surface configured to abut against the outer surface of the outer ring and to seal the outer ring against the housing.

8. The arrangement according to claim 1, wherein the outer surface of the outer ring has a profiled surface with a multitude of sealing lips.

9. The arrangement according to claim 1, wherein the peripheral surface of the inner ring and the inner surface of the outer ring have a complimentary profile that is configured to provide a secure fit between the outer ring and the inner ring.

10. The arrangement according to claim 1, wherein a width of the outer ring in a longitudinal direction of the first flat conductor is greater than a corresponding width of the inner ring, and wherein the outer ring is configured to abut with a part that projects over the inner ring against the first flat conductor and the second flat conductor.
